(19) United States
(12) Patent Application Publication
(10) Pub. No.: US 2006/0244416 A1
(43) Pub. Date: Nov. 2, 2006

(54) Battery pack having very thin thickness

(76) Inventors: Seokju Yong, Yongin-si (KR); Dongcheol Lee, Iksan-si (KR); Ju-Hwan Baek, Anyang-si (KR)

Correspondence Address: CANTOR COLBURN, LLP, 55 GRIFFIN ROAD SOUTH, BLOOMFIELD, CT, 06002, US

(21) Appl. No.: 11/394,544

(22) Filed: Mar. 31, 2006

(30) Foreign Application Priority Data
Apr. 1, 2005 (KR) 10-2005-0027672

(51) Int. Cl. H02J 7/00

(52) U.S. Cl. 320/112

(57) ABSTRACT

Disclosed herein is a battery pack. The coupling between a upper case and a lower case is accomplished by ultrasonic welding at the contact regions between the upper and lower ends thereof and a film-shaped label attached to the outer surfaces of the cases, which are coupled with each other, and the upper surface of the upper case and the lower surface of the lower case are open such that the battery body can be directly attached to the label without a step. The battery pack can be manufactured with a smaller thickness that any conventional battery packs, the heat dissipation from the battery body can be efficiently accomplished in the course of charging and discharging, and the battery pack provides structural stability required for a battery pack and an increased case coupling force.

### FIELD OF THE INVENTION

The present invention relates to a battery pack, and, more particularly, to a battery pack wherein the coupling between a upper case and a lower case is accomplished by ultrasonic welding at the contact regions between the upper and lower ends thereof and a film-shaped label attached to the outer surfaces of the cases, which are coupled with each other, and the upper surface of the upper case and the lower surface of the lower case are open such that the battery body can be directly attached to the label without a step, whereby the battery pack can be manufactured with a smaller thickness that any conventional battery packs, the heat dissipation from the battery body can be efficiently accomplished in the course of charging and discharging, and the battery pack provides structural stability required for a battery pack and an increased case coupling force.

### BACKGROUND OF THE INVENTION

As mobile devices have been increasingly developed, and the demand of such mobile devices has increased, the demand of secondary batteries has been also sharply increased as an energy source for the mobile devices. One of the secondary batteries is a lithium secondary battery having high energy density and discharge voltage, on which much research has been carried out and which is now commercially and widely used.

Based on its external shape, the lithium secondary battery is generally classified as a cylindrical battery, a rectangular battery, or a pouch-shaped battery. Based on its electrolyte, the lithium secondary battery is classified as a lithium-ion battery or a lithium-ion polymer battery. As the mobile devices have been miniaturized, the demand of the rectangular battery and the pouch-shaped battery, which have a relatively small thickness, has increased.

Furthermore, based on how the secondary battery is mounted to a case, a battery pack is generally classified as a hard battery pack or an inner battery pack. A typical example of the hard battery pack is shown in FIG. 1. Referring to FIG. 1, the hard battery pack 10 forms a part of the external appearance of an external device, to which the hard battery pack 10 is mounted. Consequently, the hard battery pack 10 has an advantage in that the hard battery pack can be easily mounted to the external device when in use. However, it is required to design a case (housing) 11 based on kinds of external devices while a battery body (not shown) is mounted in the case. As a result, the manufacturing costs of the hard battery pack 10 are high, and, furthermore, the hard battery pack 10 has low compatibility with the external devices.

On the other hand, as shown in FIG. 2, the inner battery pack 20 is mounted in an external device, and is then hidden by a cover, which forms a part of the external device. As a result, although it is relatively troublesome to mount the inner battery pack 20 in the external device, the inner battery pack 20 has advantages in that it is easy to design the inner battery pack, the manufacturing costs of the inner battery pack are low, and the inner battery pack has high compatibility with the external devices.

The details of an inner battery pack including a rectangular battery body will be described with reference to FIGS. 3 and 4. Referring to these drawings, the inner battery pack 20 comprises: a rectangular battery body 21 having a cathode terminal formed at one side thereof and an anode terminal formed at the other side thereof; a positive temperature coefficient (PTC) element 22 connected to one of the two electrode terminals for primarily protecting the battery from overcurrent, overdischarge, and overcharge; a protection circuit unit 24 connected to the PTC element 22 side electrode terminal (the cathode terminal or the anode terminal) through a nickel plate 23 and connected to the other electrode terminal through a nickel plate 27 for secondarily protecting the battery, the protection circuit unit 24 being provided at the outside thereof with external input and output terminals, through which the protection circuit unit 24 is connected to corresponding external devices (not shown); an upper case 25 and a lower case 26 for surrounding the battery body 21, the PTC elements 22, and the protection circuit unit 24.

Between the side of the battery body 21 and the nickel plate 23 and between the protection circuit unit 24 and the nickel plate 27 are disposed insulation sheets 28, which prevent short circuits due to unnecessary contact between the nickel plates 23 and the battery body 21 or between the nickel plates 27 and the protection circuit unit 24.

Also, a double-sided adhesive tape 29 is disposed between the battery body 21 and the lower case 26 such that the battery case 21 can be tightly fixed to the bottom of the lower case 26 by means of the double-sided adhesive tape 29. Consequently, when the battery body 21 is received in the upper and lower cases 25 and 26, the battery body 21 can be stably fixed in the upper and lower cases 25 and 26.

After the upper case 25 is coupled to the lower case 26, in which the battery body 21 is received, the coupled upper and lower cases 25 and 26 may be surrounded by a packing label 30, which further increases the coupling force between the upper and lower cases 25 and 26 and prevents external foreign matters from being introduced into the coupling regions between the upper and lower cases or into the upper and lower cases.

FIG. 5 is a perspective view illustrating a conventional inner battery pack including a pouch-shaped battery body, FIG. 6 is an exploded perspective view of the battery pack shown in FIG. 5, and FIG. 7 is a perspective view of the battery pack shown in FIG. 5, which is partially assembled.

Referring to these drawings, the battery pack 50 includes a pouch-shaped battery body 51 having an electrode assembly, which consists of cathodes, anodes, and separators, mounted together with an electrolyte in a sealed state, a lower case 52 having an inner space for receiving the battery pack 51, and an upper case 53 coupled to the lower case 52, in which the battery body 51 is received, for sealing the battery body 51. Also, double-sided adhesive tapes 54 are disposed between the battery body 51 and the upper and lower cases 53 and 52 such that the battery body 51 can be stably fixed in the inner space defined by the cases 52 and 53.

After the upper case 53 is coupled to the lower case 52, in which the battery body 51 is received, the coupled upper and lower cases 25 and 26 are surrounded by a packing label 40, in the same manner as the assembly process of the battery pack 20 shown in FIGS. 2 to 4, such that the coupling force between the upper and lower cases 53 and 52 is increased, and external foreign matters are prevented from being introduced into the coupling regions between the upper and lower cases or into the upper and lower cases.

In the battery pack 20 of FIG. 2 and the battery pack 50 of FIG. 5, the upper and lower cases are made of a plastic material, such as polycarbonate (PC) or polyacrylonitrile-butadiene-styrene (ABS), and the upper and lower cases are securely coupled to each other by an ultrasonic welding method. The ultrasonic welding method is a method of welding two surfaces to be attached using frictional heat generated by vibrations of high frequency, for example, 20,000 Hz.

The details of the coupling between the lower case and the upper case by the ultrasonic welding method will be described with reference to FIGS. 8 to 11. FIG. 8 is a plan view illustrating the upper case 53 mounted on the lower case 52, and FIG. 9 is a vertical sectional view (a sectional view taken along line A-A of FIG. 8) of the coupled the upper and lower cases 53 and 52. While the upper case 53 is mounted on the lower case 52, opposite ends of the upper case 53 are in contact with opposite ends of the lower case 52. FIG. 10 is a partially enlarged view illustrating the contact part B of FIG. 9 before ultrasonic welding, and FIG. 11 is a partially enlarged view illustrating the contact part B of FIG. 9 after ultrasonic welding. As shown in FIG. 10, a wedge-shaped welding ridge 61 is formed at the end of the upper case 53, and a welding surface 71 is formed at the end of the lower case 52 such that the welding surface 71 can be brought into contact with the welding ridge 61. When high-frequency vibrations are applied to the welding ridge 61 and the welding surface 71, the contact surface between the welding ridge 61 and the welding surface 71 is welded, and therefore, the welding ridge 61 and the welding surface 71 are attached to each other.

However, as the demand of small-sized battery packs having further decreased thicknesses has increased, the thicknesses of the lower case 52 and the upper case 53 have been reduced down to 0.3 to 0.35 mm in recent years. As a result, it is difficult to manufacture the lower case and-the upper case by die casting and injection molding. Furthermore, as the sizes of the welding ridge 61 and the welding surface 71 are decreased, the welding strength (the coupling force) is reduced, and therefore, poor welding rate is increased.

For this reason, a battery pack that has an adequate strength with regard to the external impacts even using small-thickness cases and that can be easily manufactured with reduced manufacturing costs is highly required.

### SUMMARY OF THE INVENTION

Accordingly, it is an object of the present invention to substantially obviate the above-mentioned problems of the conventional arts as well as the technical problems requested from the past.

As a result of a variety of extensive and intensive studies and experiments on the structure of a battery pack, the inventors of the present invention have found that, when the battery pack drops or external impacts are applied to the battery pack, the external force is concentrated to the coupling regions between the cases, and therefore, due to the small thicknesses of the bases, the side coupling parts of the cases are first broken, by which the original function of the battery pack is lost. Also, the inventors have found that the upper surface of the battery pack (the upper surface of an upper case of the battery pack) and the lower surface of the battery pack (the lower surface of a lower case of the battery pack) are not affected so long as a vertical external force is not applied to the upper surface of the battery pack or the lower surface of the battery pack, and the possibility of applying such vertical external force to the upper surface of the battery pack or the lower surface of the battery pack is relatively low in consideration of effects of the external force to the battery pack.

Consequently, the inventors have found that a small-sized battery pack having a very small thickness can be manufactured, and the battery pack has desirable mechanical stability, by the provision of a structure in which the direct coupling between the cases is accomplished at the coupling regions between the upper and lower ends of the cases, at which the interface area is relatively large, the coupling force is further increased by wrapping the outer surfaces of the cases in a film-shaped label, and the upper and lower cases are provided at the upper and lower surfaces thereof with openings, respectively, such that the height of the coupled upper and lower cases is equal to that of the battery body.

The present invention has been completed based on these findings.

In accordance with an aspect of the present invention, the above and other objects can be accomplished by the provision of a battery pack comprising: a rectangular battery body having an electrode assembly, which consists of cathodes, anodes, and separators, mounted together with an electrolyte in a sealed state; a lower case having an inner space for receiving the battery pack; and an upper case coupled to the lower case, in which the battery body is received, for sealing the battery body, wherein the coupling between the upper case and the lower case is accomplished by ultrasonic welding at the contact regions between the upper and lower ends thereof and a film-shaped label attached to the outer surfaces of the cases, which are coupled with each other, and the upper surface of the upper case and the lower surface of the lower case are open such that the battery body can be directly attached to the label without a step.

One of the characteristics of the battery pack according to the present invention is that the ultrasonic welding used to couple the upper and lower cases is carried out only at the contact regions between the upper and lower ends of the cases, not at the side contact regions of the cases. The battery pack is constructed in a structure in which the battery body is mounted in the cases such that a protection circuit unit can be stably mounted to the battery body, and the battery body can be protected from the outside. Consequently, the coupled upper and lower cases have an inner space for receiving the battery body and the protection circuit unit, and the upper contact region, at which the protection circuit unit is mounted, and the lower contact region, which forms the lower end of the battery pack, have greater contact interface areas than the side contact regions. As previously described, it is required that welding ridges and welding surfaces be formed at the contact regions in order to perform ultrasonic welding, and the greater the interface areas are, the higher the coupling force is. Consequently, the upper and lower end contact regions are suitable to perform the ultrasonic welding. The decrease of the coupling force caused by omitting the ultrasonic welding with respect to the side contact regions is supplemented by the provision of a film-shaped label, which is attached around the outer surfaces of the cases such that the label wraps the cases. Since the ultrasonic welding is not performed at the side contact regions, the width of the cases (the distance between opposite sides of the cases) is further decreased, and therefore, it is possible to manufacture a small-sized battery pack, the whole size of which is very small.

Another characteristic of the battery pack according to the present invention is that the upper surface of the upper case and the lower surface of the lower case are open such that the battery body can be directly attached to the label without a step. Here, the term “without a step” means that the upper surface of the upper case and the lower surface of the lower case are open in a structure in which there is no height deviation between the upper and lower cases and the battery body such that the total height of the coupled upper and lower cases is equal to the height of the battery body when the upper case and the lower case are coupled to each other while the battery body is mounted in the upper case and the lower case. By virtue of this structure, the total thickness of the battery pack is equal to the thickness of the battery body, excluding the thickness of the label. Consequently, it is possible to manufacture a battery pack having a very small thickness. Also, heat generated from the batter body in the course of charging and discharging is more efficiently dissipated by virtue of the above-described open structure of the upper and lower cases.

In a preferred embodiment, the upper case is constituted by a frame member having side walls, which extend downward, and the lower case is constituted by a frame member having side walls, which extend upward. Consequently, when the upper and lower cases are coupled with each other, the sides of the battery body are surrounded by the side walls of the upper and lower cases. More preferably, coupling protrusions and coupling grooves are formed at the side walls of the upper and lower cases such that the coupling protrusions and the coupling grooves can be engaged with each other in an assembled state.

In another preferred embodiment, the battery pack further comprises: shoulders, at which the upper surface and the side walls of the upper case meet each other, the shoulders being gently bent in the sectional shape of a curve. This gently-bent curve structure is a wide arch-shaped structure, which is relatively stable when external impacts are applied to the upper corners. This gently-bent curve structure is also applied to the lower case in the same manner.

The material for the upper case and the lower case is not particularly restricted. At least the contact regions between the upper and lower ends of the upper and lower cases, at which the ultrasonic welding is performed, are made of a plastic material, such as polycarbonate (PC) or polyacrylonitrile-butadiene-styrene (ABS). Consequently, the entire cases, including the contact regions between the upper and lower ends of the upper and lower cases, may be made of a plastic material or a composite material including plastic and metal.

The label is attached to the upper and lower cases, such that the outer surfaces of the coupled upper and lower cases, in which the battery body is mounted, can be fully surrounded by the label, for further increasing the coupling force between the upper and lower cases and protecting the battery body and the cases from the outside. The label is a one-unit film or a two-unit film. The overlapping parts of the label are coupled to each other after the upper and lower cases are fully surrounded by the label, whereby the label is attached to the cases and the battery body. The coupling of the overlapping parts may be accomplished by various methods, for example, attachment using adhesive, thermal welding, or addition of an adhesive member or a coupling member. However, the coupling may be accomplished by other different methods except the above-specified methods. Furthermore, adhesive may be applied between the label, the cases and the battery body, whereby the coupling force is further increased.

The material for the label is not particularly restricted. For example, the label may be made of a plastic material, such as polycarbonate (PC) or polyethylene terephthalate (PET), a thin metal material, or a composite material including plastic and metal. Also, the label may be made of a reinforcing material, which is a plastic base having a fibrous reinforcing agent, such as short fiber, long fiber, non-woven fabric, or woven fabric, which increases the strength of the label. Most preferably, the label is made of the plastic material. The desirable thickness of the label is approximately 0.1 to 0.2 mm in consideration of the thickness of the battery pack and the function of the label as the protecting member. However, the thickness of the label is not restricted by the above-specified sizes.

A rectangular or pouch-shaped battery body may be mounted in the battery pack according to the present invention. Preferably, the battery body is a lithium-ion secondary battery or a lithium-ion polymer secondary battery.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a perspective view illustrating a hard battery pack;

FIG. 2 is a perspective view illustrating a conventional inner battery pack including a rectangular battery body;

FIG. 3 is an exploded perspective view of the battery pack shown in FIG. 2;

FIG. 4 is a perspective view of the battery pack shown in FIG. 2, which is partially assembled;

FIG. 5 is a perspective view illustrating a conventional inner battery pack including a pouch-shaped battery body;

FIG. 6 is an exploded perspective view of the battery pack shown in FIG. 5;

FIG. 7 is a perspective view of the battery pack shown in FIG. 5, which is partially assembled;

FIG. 8 is a plan view illustrating a conventional battery pack;

FIG. 9 is a sectional view taken along line A-A of FIG. 8;

FIG. 10 is a partially enlarged view illustrating the part B of FIG. 9 before ultrasonic welding;

FIG. 11 is a partially enlarged view illustrating the part B of FIG. 9 after ultrasonic welding;

FIG. 12 is an exploded perspective view illustrating a battery pack according to a preferred embodiment of the present invention;

FIG. 13 is an assembled perspective view illustrating the battery pack according to the preferred embodiment of the present invention;

FIG. 14 is a typical view illustrating an assembly process of applying a one-unit label to the outer surface of a battery pack according to another preferred embodiment of the present invention;

FIG. 15 is a plan view illustrating a battery pack according to a preferred embodiment of the present invention;

FIG. 16 is a sectional view taken along line C-C of FIG. 15; and

FIG. 17 is a partially enlarged view illustrating the part D of FIG. 16.

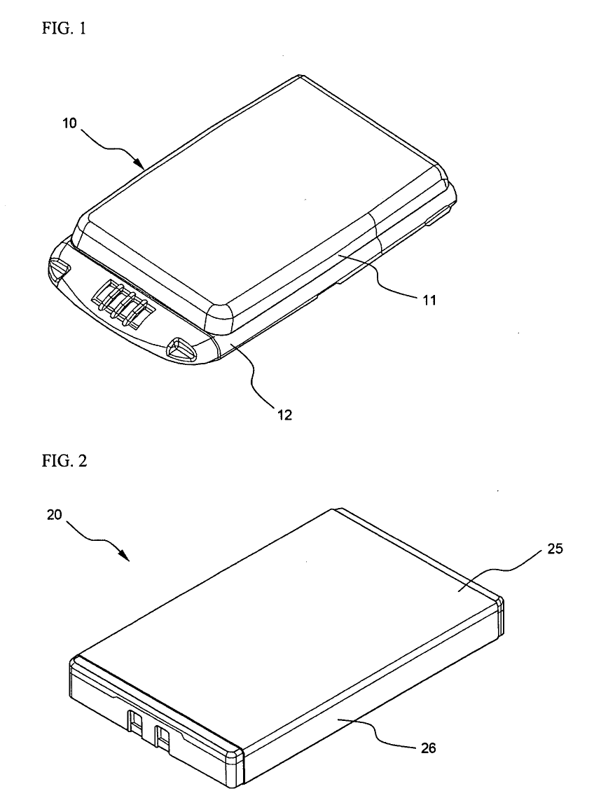

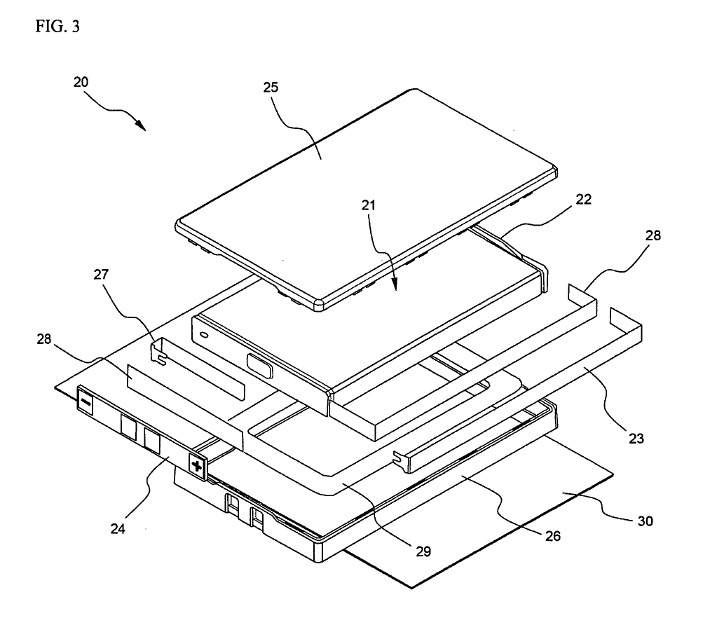

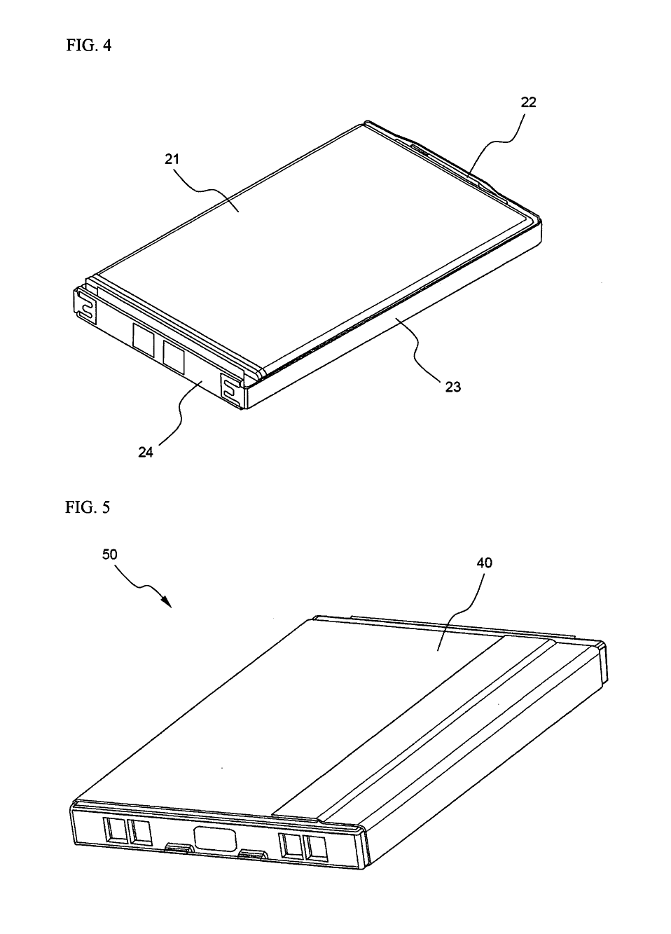

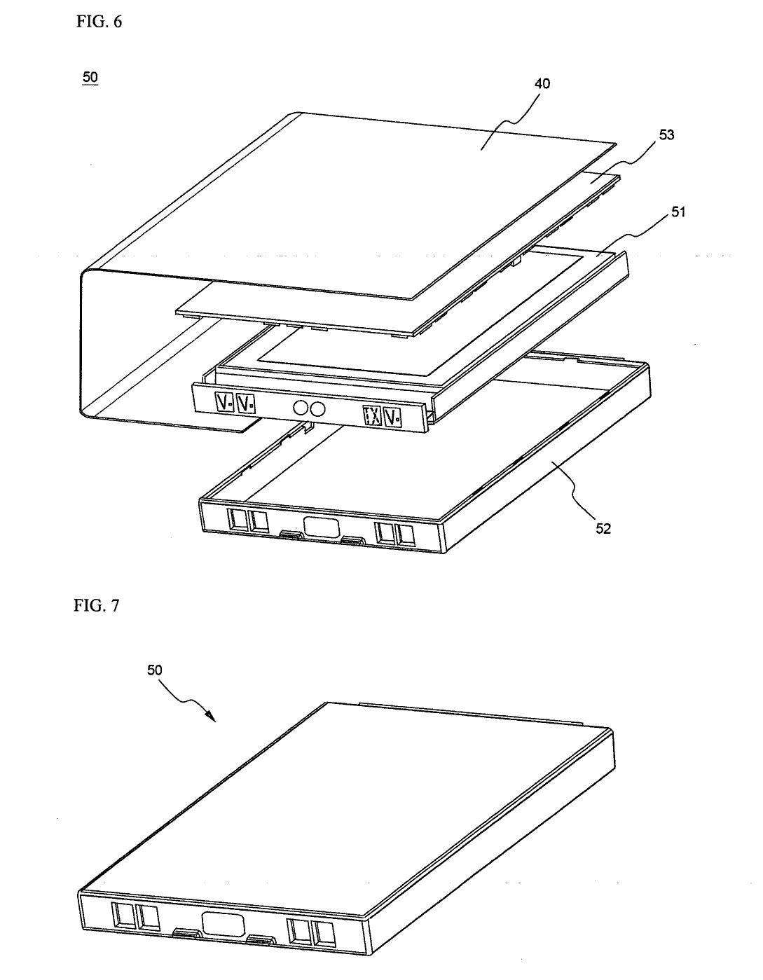

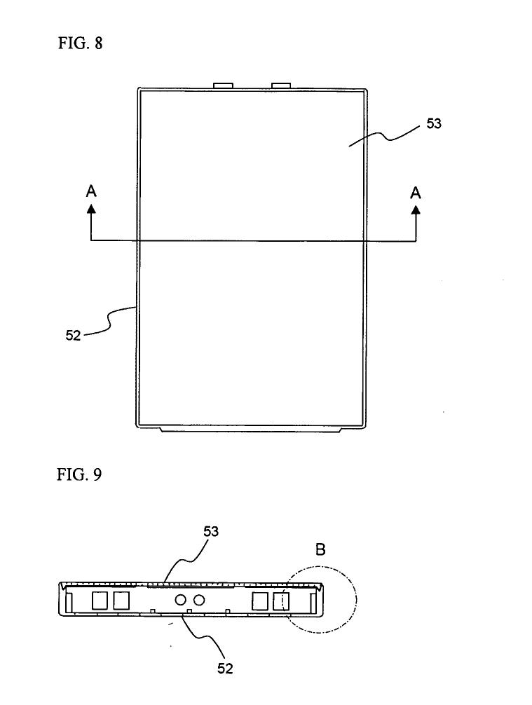

### DETAILED DESCRIPTION OF PREFERRED EMBODIMENTS

Now, preferred embodiments of the present invention will be described in detail with reference to the accompanying drawings. It should be noted, however, that the scope of the present invention is not limited by the illustrated embodiments.

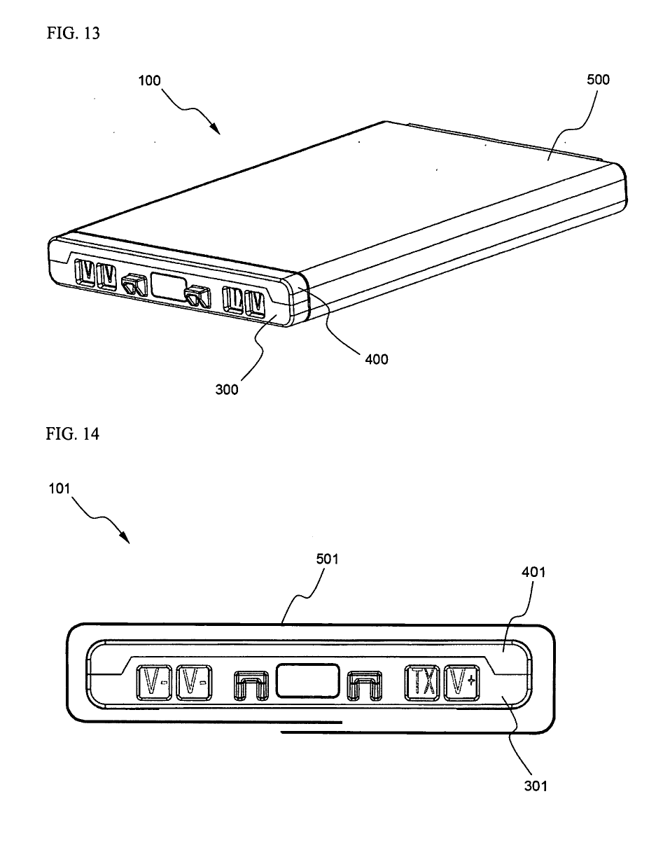

FIG. 12 is an exploded perspective view illustrating a battery pack according to a preferred embodiment of the present invention, and FIG. 13 is an assembled perspective view illustrating the battery pack according to the preferred embodiment of the present invention.

Referring to FIGS. 12 and 13, the battery pack 100 includes a battery body 200 having an electrode assembly, which consists of cathodes, anodes, and separators, mounted together with an electrolyte in a sealed state, a lower case 300 for receiving the battery pack 200, and an upper case 300 coupled to the lower case 300 for sealing the battery body 200.

To the upper end of the battery body 200 are mounted protection circuit devices, such as a protection circuit module (PCM) 210 and a positive temperature coefficient (PTC) element.

The lower case 300 has an inner surface corresponding to the outer surface of the battery body 200 such that the battery body 200 can be located on the lower case 300. At an upper frame 310 are formed terminal windows 312 and 314, through which external input and output terminals 212 and 214 of the PCM 210 are exposed.

The lower case 300 and the upper case 400 are formed in a frame structure in which the upper surface of the lower case 300 and the lower surface of the upper case 400 are open. At opposite sides of the lower case 300 are formed side walls 320, which extend upward. At opposite sides of the upper case 400 are formed side walls 420, which extend downward. Also, shoulders 330, at which the lower surface and the side walls 320 of the lower case 300 meet each other, are gently bent in the sectional shape of a curve. Similarly, shoulders 430, at which the upper surface and the side walls 420 of the upper case 400 meet each other, are gently bent in the sectional shape of a curve. Consequently, the lower case 300 and the upper case 400 together form an arch-shaped symmetrical structure, and therefore, the lower case 300 and the upper case 400 are structurally stable with respect to an external force applied to the lower case 300 and the upper case 400.

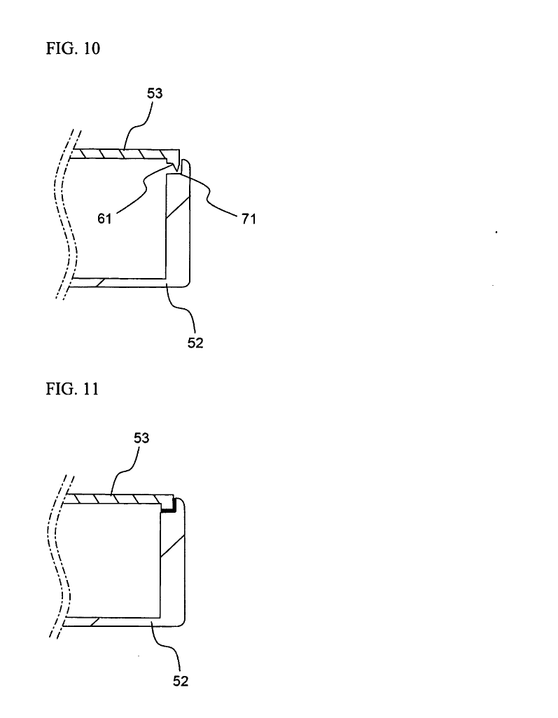

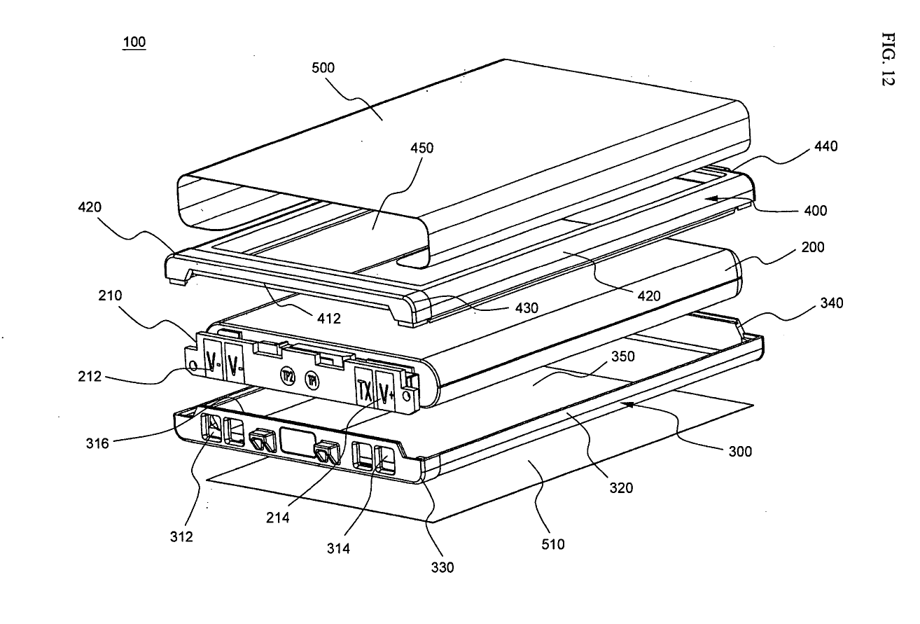

The upper and lower cases 400 and 300 are coupled to each other by ultrasonic welding. Specifically, an upper frame 410 and a lower frame 440 of the upper case 400 are coupled to an upper frame 310 and a lower frame 340 of the lower case 300, respectively. At the end of the upper frame 410 of the upper case 400, which is brought into contact with the upper frame 310 of the lower case 300, is formed a welding ridge 412. At the end of the upper frame 310 of the lower case 300 is formed a welding surface 316, which corresponds to the welding ridge 412. The upper frames 310 and 410 and the lower frames 340 and 440 have a thickness greater than that of the side frames constituting the side walls 320 and 420. As a result, the upper frames 310 and 410 and the lower frames 340 and 440 provide interface area sufficient for ultrasonic welding. The welding ridge 412 and the welding surface 316 may be formed in reverse. The ultrasonic welding at the welding ridge 412 and the welding surface 316 is the same as the case of FIGS. 10 and 11.

The upper surface and the lower surface of the battery body 200 are exposed through an opening of the upper case 400 and an opening 350 of the lower case 300, respectively.

To the outer surfaces of the upper and lower cases 400 and 300, which are coupled to each other, are attached a pair of labels 500 and 510, respectively. To the inner surfaces of the labels 500 and 510 are applied adhesive, by which the labels 500 and 510 can be securely fixed to each other not only at the overlapping region between the labels 500 and 510 but also to the upper and lower cases 400 and 300 and the outer surface of the battery body 200 exposed through the openings 450 and 350 of the upper and lower cases 400 and 300.

FIG. 14 is a front view illustrating a battery pack 101 according to another preferred embodiment of the present invention.

Referring to FIG. 14, a label 501 is constructed in a one-unit structure having a length sufficient to cover the entire outer surfaces of the upper and lower case 400 and 300, which is different from the labels 500 and 501 of FIG. 12.

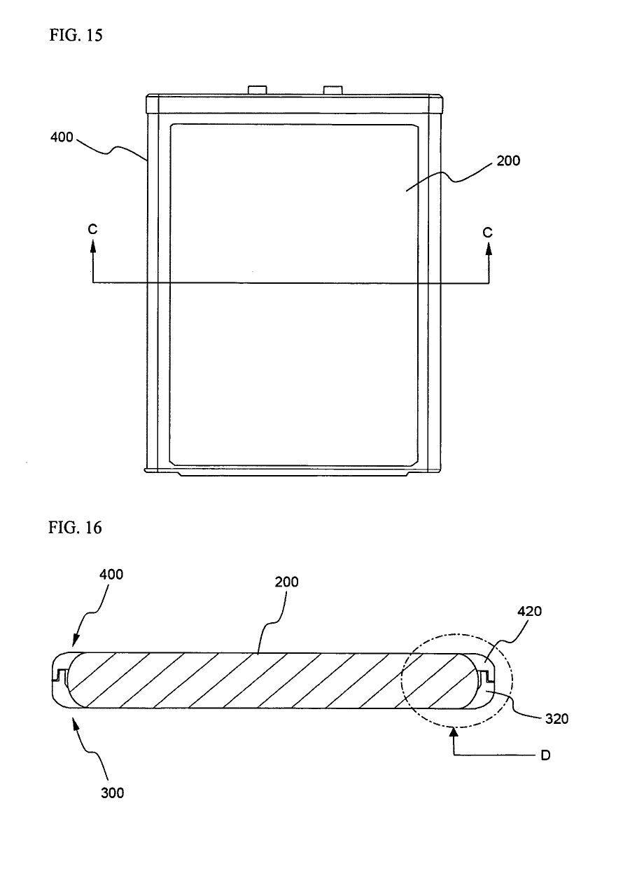

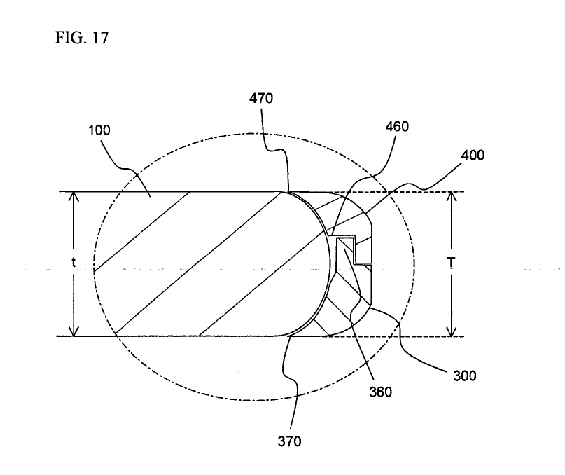

FIG. 15 is a plan view illustrating a battery pack 100 according to a preferred embodiment of the present invention, FIG. 16 is a vertical sectional view of the battery pack 100, and FIG. 17 is an enlarged view, in section, of the side wall part of the battery pack 100. For the convenience of understanding, no label is shown in the drawings.

Referring first to FIG. 15, the upper surface of the battery body 200 is exposed from the upper case 400. Consequently, heat generated from the battery body 200 in the course of charging and discharging is efficiently dissipated, and therefore, the optimum operation of the battery body 200 is accomplished.

Referring to FIGS. 16 and 17, a coupling protrusion 360 and a coupling groove 460 are formed at the side wall 320 of the lower case 300 and the side wall 420 of the upper case 400, respectively, such that the coupling protrusion 360 can be engaged with the coupling groove 460. The coupling protrusion 360 and the coupling groove 460 may be formed in reverse. According to circumstances, coupling protrusion 360 and the coupling groove 460 may be differently formed at the right and left side walls. Also, the shapes of the coupling protrusion 360 and the coupling groove 460 are not particularly restricted. In other words, the coupling protrusion 360 and the coupling groove 460 may be formed in various shapes. According to circumstances, the coupling protrusion and the coupling groove may not be formed. As a result, the ultrasonic welding is not performed at the side walls 320 and 420 of the cases 300 and 400. Consequently, it is possible to manufacture a case whose side has a small thickness without particular restriction.

Referring again to FIG. 17, the battery body 200 is mounted into the upper and lower cases 400 and 300 without a step. Consequently, the battery body 200 has a thickness (t) equal to a thickness (T) of the battery pack 100 so long as the label (not shown) is not attached to the battery pack 100. Specifically, an inner-side end 370 of the lower case 300 and an inner-side end 470 of the upper case 400 are brought into contact with the surface of the battery body 200, and do not protrude outward. By virtue of this structure, the battery body 200 can be stably fixed to the upper and lower cases 400 and 300. Furthermore, the battery pack can be manufactured with a very small thickness.

The battery pack according to the present invention is preferably used for an inner battery pack.

Although the preferred embodiments of the present invention have been disclosed for illustrative purposes, those skilled in the art will appreciate that various modifications, additions and substitutions are possible, without departing from the scope and spirit of the invention as disclosed in the accompanying -claims.

### INDUSTRIAL APPLICABILITY

As apparent from the above description, the battery pack according to the present invention can be manufactured with a smaller thickness that any conventional battery packs. Also, the heat dissipation from the battery body can be efficiently accomplished in the course of charging and discharging. Furthermore, the battery pack according to the present invention provides structural stability required for a battery pack and an increased case coupling force.

What is claimed is:

1. A battery pack comprising: a rectangular battery body having an electrode assembly, which consists of cathodes, anodes, and separators, mounted together with an electrolyte in a sealed state; a lower case having an inner space for receiving the battery pack; and an upper case coupled to the lower case, in which the battery body is received, for sealing the battery body, wherein
the coupling between the upper case and the lower case is accomplished by ultrasonic welding at the contact regions between the upper and lower ends thereof and a film-shaped label attached to the outer surfaces of the cases, which are coupled with each other, and the upper surface of the upper case and the lower surface of the lower case are open such that the battery body can be directly attached to the label without a step.

2. The battery pack according to claim 1, wherein the upper case is constituted by a frame member having side walls, which extend downward, and the lower case is constituted by a frame member having side walls, which extend upward.

3. The battery pack according to claim 1, further comprising:
coupling protrusions and coupling grooves formed at the side walls of the upper and lower cases such that the coupling protrusions and the coupling grooves can be engaged with each other in an assembled state.

4. The battery pack according to claim 1, further comprising:
shoulders, at which the upper surface and the side walls of the upper case meet each other, the shoulders being gently bent in the sectional shape of a curve.

5. The battery pack according to claim 1, further comprising:
shoulders, at which the lower surface and the side walls of the lower case meet each other, the shoulders being gently bent in the sectional shape of a curve.

6. The battery pack according to claim 1, wherein the contact regions between the upper and lower ends of the upper and lower cases are made of a plastic material, such as polycarbonate (PC) or polyacrylonitrile-butadiene-styrene (ABS).

7. The battery pack according to claim 1, wherein the label is a one-unit film or a two-unit film, the overlapping parts of the label being coupled to each other after the upper and lower cases are fully surrounded by the label, whereby the label is attached to the cases and the battery body.

8. The battery pack according to claim 1, wherein the label is made of a plastic material, such as polycarbonate (PC) or polyethylene terephthalate (PET), and the label has a thickness of 0.1 to 0.2 mm.

9. The battery pack according to claim 1, wherein the battery body is a lithium-ion secondary battery or a lithium-ion polymer secondary battery.
